(19) United States
(12) Patent Application Publication
(10) Pub. No.: US 2025/0198269 A1
(43) Pub. Date: Jun. 19, 2025

(54) MULTI FUNCTIONAL FRACTURING BLENDER

(71) Applicant: Freemyer Industrial Pressure, L.P., Fort Worth, TX (US)

(72) Inventors: Greg Leos, Fort Worth, TX (US); Len Freemyer, 9825 Old Decatur Rd, TX (US); Heston Starkey, Fort Worth, TX (US); Siva Kunchala, Fort Worth, TX (US)

(21) Appl. No.: 18/541,816

(22) Filed: Dec. 15, 2023

(51) Int. Cl. E21B 43/26; B01F 23/53; B01F 33/502; B01F 101/49

(52) U.S. Cl. CPC E21B 43/2607; B01F 23/53; B01F 33/502; B01F 2101/49

(57) ABSTRACT

A blending apparatus utilized in hydraulic and simultaneous well servicing operations. The apparatus comprises a tub with multiple blending sections that can function as a single or multi-section blending unit and a plurality of mixing paddles mounted on a shaft and disposed within the tub. The mixing paddles have a helical shape screw inside a cylindrical body that enhances mixing and helps reduce air from the tub system.

### TECHNICAL FIELD

The present invention generally relates to a blending apparatus used in hydraulic and simultaneous well fracturing operations. More specifically, the present invention relates to a blending tub apparatus operable to function as a single or partitioned blending tub with multiple blending sections.

### BACKGROUND

To increase the production of an oil, gas, geothermal, or other type of well, the producing zone of the geological formation surrounding the well is fractured to allow the desired fluids to flow more freely through the formation and into the well. Fluid is pumped into the formation under high pressure to fracture the producing zones. However, if fracturing fluid is pumped into the formation during the fracturing operation without some accompanying solid, the geological formation pressures will cause the fractured areas of the formation to close when the pumping of fracturing fluid stops, thus restricting the flow of the oil or gas.

A slurry of particulate material, such as sand blended with the fracturing fluid, may be forced into the fissures in the geological formation to keep the formation open after the slurry has been pumped into the well. Blending tubs are used to mix the particulate material with the fracturing fluid. The slurry is discharged to a downhole pump and injected into the well and into the producing zones.

Some in the industry believe the simultaneous use of multiple blending tubs in fracturing operations for delivery of slurry is desirable as it increases flow rate of the slurry being discharged and provides a failsafe backup system in the event that one of the blending tubs fails. See U.S. Pat. No. 6,193,402. The prior art recognizes that it is difficult to use multiple tubs simultaneously for delivery of slurry. The prior art addresses this problem by discharging the slurry from the multiple blending tubs at a constant high flow rate and pressure into a single discharge manifold to be combined for delivery. In this type of system, the slurry does not build up in the blending tubs, and therefore throttle valves are not required to control the discharge flow rate and leveling of slurry within the tubs is not required.

Others in the industry have attempted to use independent blending tubs for delivery of fluid to two or more wells for simultaneous fracturing. The prior art recognizes that a challenge with simultaneously treating multiple wells with a single primary fluid pumping system is that the flow distribution to each well is directly a function of the inherent resistance of each well, and addresses this inherent resistance problem by using friction modifiers to alter the frictional resistance of each well individually. See WO 2020/145979. In this type of system, alteration of inherent resistance is used to control fluid flow to each of the multiple wells, instead of using valves, chokes, and/or other “point-source” flow control devices.

A potential problem with conventional blending apparatuses is that they have limited capacity and flexibility. The conventional blending apparatuses can only blend one type of fluid mixture at a time and cannot be adjusted to different wells and conditions or requirements. Moreover, conventional blending apparatuses may result in air entrainment.

The present invention provides a solution to the above-mentioned problems by providing a blending tub apparatus that can function as a single or multi-section blending unit and provides improved mixing performance. The multiple blending tub apparatus can blend different fluid mixtures simultaneously, increasing the capacity and flexibility of the operation, which can provide the different fluid mixtures for use in simultaneous fracturing of different wells. The blending tub apparatus may reduce the costs and size of the equipment used to generate the multiple fluid mixtures and the footprint of the well site, such as by eliminating component redundancies of separate blending tubs, a second trailer or skid at the well site, a secondary blender, a separate fluid source, a chemical additive source, and/or a particulate matter delivery system for the secondary blender. Moreover, the blending apparatus can help eliminate air from the tub system, improving the mixing performance and the fracture conductivity of the fluid mixtures that is produced.

### SUMMARY

In one embodiment of the present invention, a blending tub system for producing slurry for use in well servicing operations may comprise a multi-sectional blending tub, a divider insertable from the top and positioned within the blending cavity of the blending tub to separate the blending tub into a first section and a second section, fluid inlets that transport fracturing fluid to the sections of blending tub, mixing impellers that blend the particulate matter and the fracturing fluid to create separate slurry compositions within the sections of the blending tub, and outlets to discharge the slurry compositions from the sections of the blending tub.

The blending tub system may further comprise a particulate delivery system for delivery of particulate matter into the sections of the blending tub, The particulate delivery system may include a distribution chute that transports the particulate matter to the first and second sections of the blending tub through particulate inlets disposed in the side wall of the blending tub.

The blending tub system may further comprise a manifold system for intake of fluid to and discharge of slurry mixtures from the blending tub. The manifold system may comprise an intake manifold system including intake pumps and intake control valves for the intake of fluid to each section of the blending tub, and a discharge manifold system including discharge pumps and discharge control valves for discharging the slurry mixture from each section of the blending tub.

The blending tub system may further comprise a power generation system to power and control the delivery system, manifold system, and the mixing impellers of the blending tub. The power generation system may comprise a generator, one or more electric motors to power the intake pumps, discharge pumps, and the mixing impellers, one or more variable frequency drives send power to and control the speed of the electric motors,

The components of the blending tub system may be mounted on a single transportable base, which may comprise comprises one of a trailer, truck chassis, and skid.

The blending tub system may be operable to generate more than one composition of slurry at a time for use by multiple pumps in simultaneous fracturing of multiple wells, or, alternatively, it may be used to generate multiple tubs of slurry of the same composition to serve as a back-up for fracturing of a single well.

The blending tub system may also be operated as a single blending tub by removing the divider from the blending tub. In this configuration, the system may also include mixing impellers that mix the slurry within the single blending tub. The slurry composition from the single blending tub may be delivered for fracturing of a single well.

### BRIEF DESCRIPTION OF THE DRAWINGS

FIG. 1 depict a side view of an embodiment of a multi-sectional blending tub system;

FIG. 2 depicts an isometric view of the embodiment of the multi-sectional blending tub system according to FIG. 1;

FIG. 3 depicts an isometric view of an embodiment of the multi-sectional blending tub system according to FIG. 1 without a conveyor system.

FIG. 4 depicts a schematic in a plan view of an embodiment of a multi-sectional blending tub system depicting a manifold system in fluid communication with a multi-sectional blending tub; and

FIG. 5 depicts a cross-sectional view of an embodiment of a multi-sectional blending tub taken along line A-A of FIG. 4.

FIGS. 6-7 depict an isometric and a side view of an impeller for the multi-sectional blending tub.

FIG. 8 depicts a cross-sectional view taken along line B-B of FIG. 7

Repeat use of reference characters in the present specification and drawings is intended to represent the same or analogous features or elements of the present subject matter.

### DETAILED DESCRIPTION

Embodiments of the present invention are further described in detail below with reference to the accompanying drawings and embodiments. The following examples are intended to illustrate the invention, but are not intended to limit the scope of the invention.

“Hydraulic fracturing” or “fracturing” as used herein will be understood to refer to the oil and gas well development process of injecting water, sand, and chemicals under high pressure into a bedrock formation via a well. The process is typically used in low-permeability rocks such as shale.

“Simultaneous fracturing” or “simulfrac” as used herein will be understood to refer to the simultaneous fracturing of two or more wells located on the same well pad.

“Particulate matter” as used herein will be understood to refer to sand, glass beads, walnut shells, poly abrasive or other suitable materials that may be blended with fracturing fluid to create a slurry suitable for fracturing or simulfrac operations.

“Fracturing fluid” as used herein will be understood to refer to water, water-based fluid, gelled oil-based fluids, acid-based fluid, foam fluids, or other suitable fluids that may be blended with particulate matter to create a slurry suitable for fracturing or simulfrac operations.

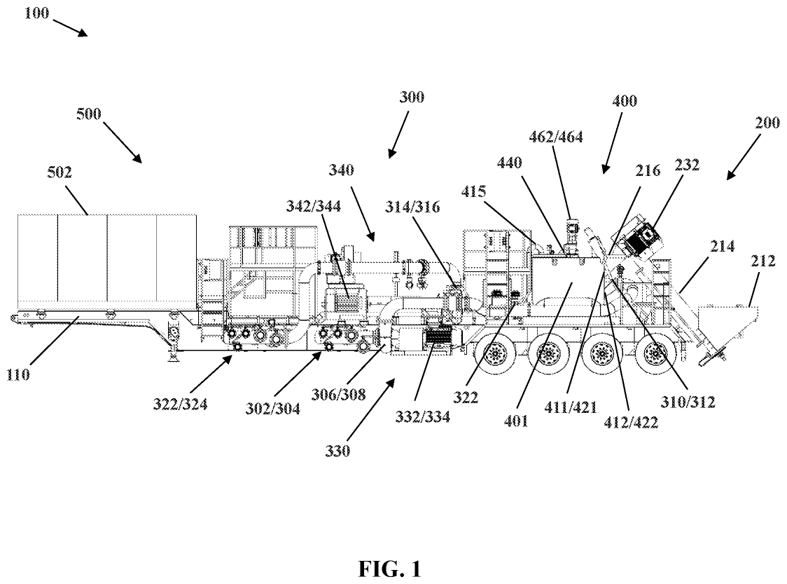

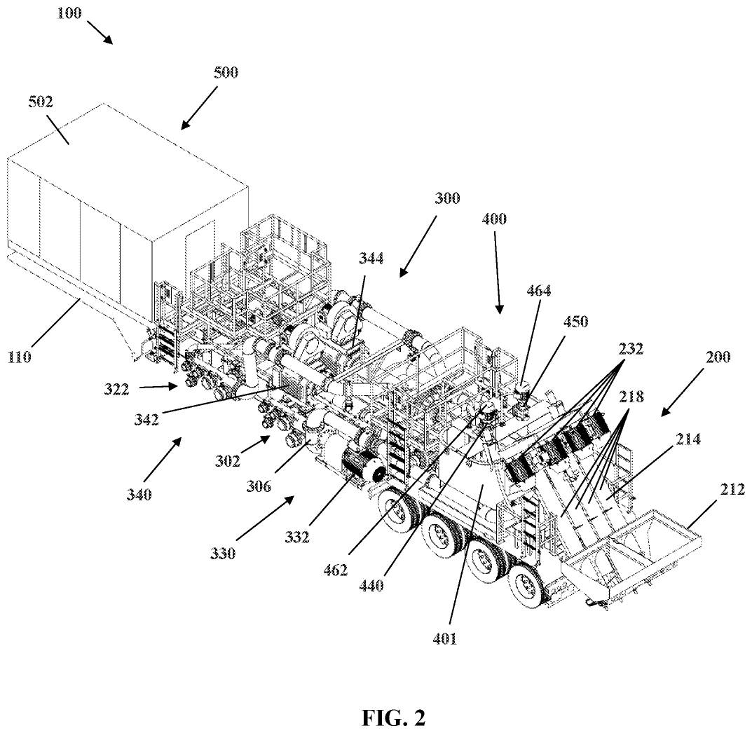

Referring to FIGS. 1-2, a side view and isometric view of an embodiment of a multi-sectional blending tub system 100 are illustrated. Multi-sectional blending tub system 100 may comprise a particulate delivery system 200, a manifold system 300, a multi-sectional blending tub 400, and a power generation system 500. The multi-sectional blending tub system 100 may be powered by electric motors, hydraulic power, internal combustion engines, including diesel fuel, dual fuel diesel/gas, or similar means. The components of the multi-sectional blending tub system 100 may be mounted on a transportable support base 110, which may comprise a trailer, truck chassis, skid, or other transportation device suitable to support and transport the system.

The particulate delivery system 200 may be used to transport particulate matter to the multi-sectional blending tub 400. The blending tub 400 may have a blending cavity 406 partitioned to define a first section 410 and a second section 420. The particulate delivery system 200 may comprise a hopper 212, a conveyer system 214, and a distribution chute 216. The hopper 212 is operable to receive particulate matter. The conveyer system 214 may be operable to transport the particulate matter from the hopper 212 to the distribution chute 216 and into the first section 410 and second section 420 of the blending tub 400.

The conveyer system 214 may utilize a conveyer belt, positive displacement screw, sand screw, augers, or similar devices to transport the particulate matter. In one embodiment, the conveyer system 214 comprises a screw assembly including a plurality of sand screws or augers 218. Each sand screw or auger 218 may be powered simultaneously or separately, depending on the desired amount of particulate matter. The speed of each sand screw or auger 218 may also be altered to adjust the amount of particulate matter that is fed into each section of the multi-sectional blending tub 400. The conveyer system 214 may use two to four sand screws or augurs 218 for the multi-sectional blending tub 400. The sand screws or augers 218 may be removable or interchangeable to allow for greater end user flexibility in determining how best to add particulate matter to the particulate delivery system 200 in the given situation.

In one embodiment, a single hopper 212 may be used to provide the particulate matter to the conveyor system 214. In another embodiment, multiple hoppers 212 may be used to facilitate separation of a first and a second particulate matter.

The distribution chute 216 may be operable to receive the particulate matter from the conveyer system 214 and transport the particulate matter to the multi-sectional blending tub 400. A baffle 220 may be provided within the distribution chute 216 for diverting and controlling the flow of particulate matter to each section of the multi-sectional blending tub 400. In this way, the baffle 220 facilitates the separation of a first particulate matter from a second particulate matter within the distribution chute 216.

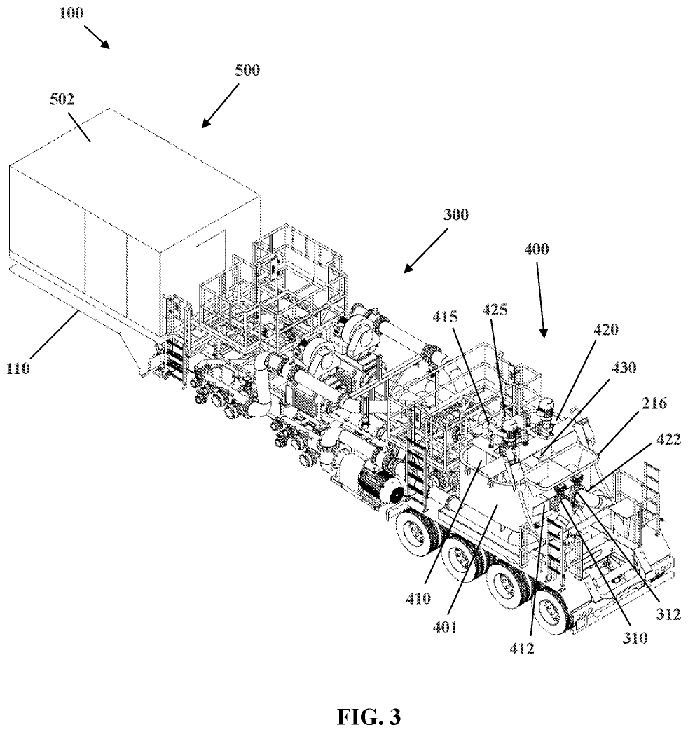

FIG. 3 depicts an embodiment of the multi-sectional blending tub system 100 without the conveyor system 214. The particulate delivery system 200 may utilize a gravity feed to transport the particulate matter to the multi-sectional blending tub 400 from a raised hopper 212 suspended above the blending tub 400.

As shown in FIG. 3, the particulate matter may be transported to the distribution chute 216 for insertion into the multi-sectional blending tub 400 through one or more particulate inlet ports 411, 421 in a side wall 401 of the blending tub (i.e., at a substantially horizontal, inclined, or declined angle), as opposed to the conventual method of inserting particulate matter into blending tubs from directly above (i.e., at a substantially vertical angle). The particulate inlet ports 411, 421 may be located at a height above the maximum fill level of the blending tub. One benefit of delivering particulate matter from a side wall closer to or below the level of the fluid within the blending tub is that it reduces the amount of air entering into the top of the mixture in the blending tub 400, and therefore reduces aeration and cavitation in blending tub. Reducing aeration and cavitation prolongs the functioning lifespan of fracturing components and provides a more homogenous composition within the mixture in the blending tub.

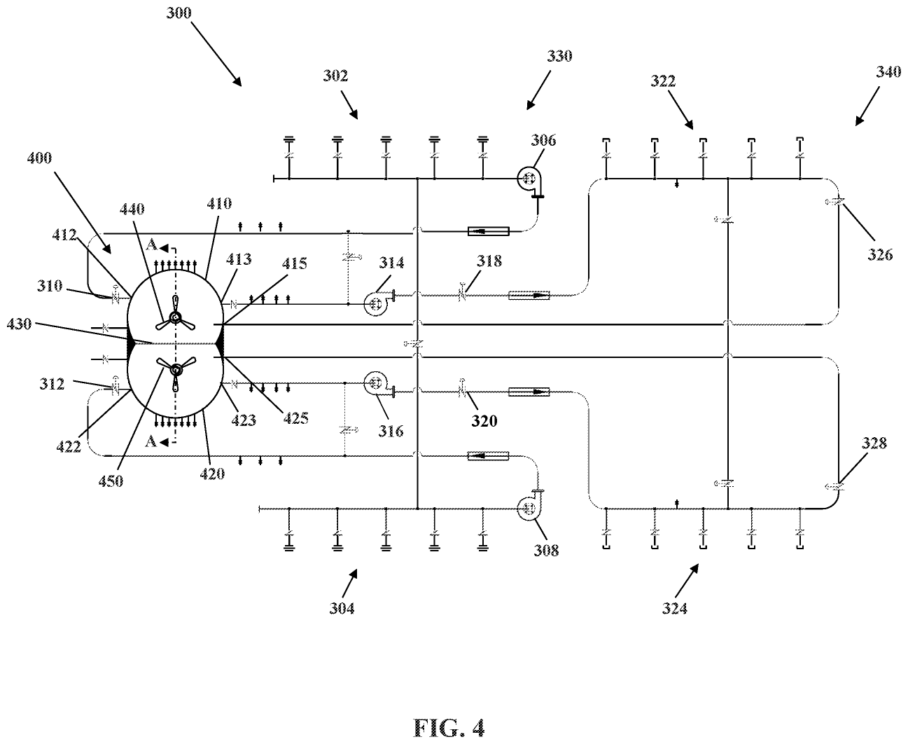

Referring to FIG. 4, a schematic of an embodiment of a multi-sectional blending tub system depicting a manifold system 300 for intake of fluid for and discharge of slurry mixtures from a multi-sectional blending tub 400.

The manifold system 300 may include an intake manifold system 330 that is operable to transport fracturing fluid to the multi-sectional blending tub 400. In this way, the intake manifold system 330 may comprise a first set of intake hose connectors 302, a second set of intake hose connectors 304, a first intake pump 306, a second intake pump 308, a first intake control valve 310, and a second intake control valve 312, all in fluid communication with each other. For example, the intake pumps 306, 308 may be suction centrifugal pumps. The valves may be equipped with electric powered valve actuators, air powered valve actuators, or manual operated valve handles.

The manifold system 300 may include a discharge manifold system 340 that is operable to transport slurry mixtures discharged from the multi-sectional blending tub 400. In this way, the discharge manifold system 340 may comprise a first discharge pump 314, a second discharge pump 316, a first discharge control valve 318, a second discharge control valve 320, a first set of discharge hose connectors 322, a second set of discharge hose connectors 324, a first prime up valve 326, and a second prime up valve 328, all in fluid communication with each other. For example, the discharge pumps 314, 316 may be discharge centrifugal pumps. The valves may be equipped with electric powered valve actuators, air powered valve actuators, or manual operated valve handles.

A first fracturing fluid source may be connected to one or more of the intake hose connectors in the first set of intake hose connectors 302. The first intake connectors 302 may provide for the intake of a fluid and chemical additives for the first fracturing fluid. The first intake pump 306 may transport the first fracturing fluid to the first intake control valve 310. The first intake control valve 310 may regulate the amount of first fracturing fluid that enters the first section 410 of the multi-sectional blending tub 400 via the first fracturing fluid inlet 412. A first particulate matter may be added to the first section 410 via the distribution chute 216. A first impeller 440 may be used to mix the first fracturing fluid and the first particulate matter to create the first slurry. The first slurry may exit the multi-sectional blending tub 400 via the first discharge outlet 413, which may lead to the first discharge pump 314. The first slurry may be transported from the first discharge pump 314 to the first discharge control valve 318, which may regulate the amount of first slurry that is distributed to the first set of discharge hose connectors 322. First prime up valve 326 may allow the first fluid from the first section 410 to prime up the first discharge pump 314 to the first prime up inlet 415. The first prime up valve 326 may prime up the first discharge pump 314 by eliminating air from the first discharge pump 314. The first fluid may then be transported directly to the first set of discharge hose connectors 322.

A second fracturing fluid source may be connected to one or more of the intake hose connectors in the second set of intake hose connectors 304. The second intake connectors 304 may provide for the intake of a fluid and chemical additives for the second fracturing fluid. The second intake pump 308 may transport the second fracturing fluid to the second intake control valve 312. The second intake control valve 312 may regulate the amount of second fracturing fluid that enters the second section 420 of the multi-sectional blending tub 400 via the second fracturing fluid inlet 422. A second particulate matter may be added to the second section 420 via the distribution chute 216. A second impeller 450 may be used to mix the second fracturing fluid and the second particulate matter to create the second slurry. The second slurry may exit the multi-sectional blending tub 400 via the second discharge outlet 423, which may lead to the second discharge pump 316. The second slurry may be transported from the second discharge pump 316 to the second discharge control valve 320, which may regulate the amount of second slurry that is distributed to the second set of discharge hose connectors 324. Second prime up valve 328 may allow the second fluid from the second section 420 to prime up the second discharge pump 316 to the second prime up inlet 425. The second prime up valve 328 may prime up the second discharge pump 316 by eliminating air from the second discharge pump 316. The second fluid may then be transported directly to the second set of discharge hose connectors 324.

The intake control valves 310, 312, in combination with the discharge control valves 318, 320, and the prime up valves 326, 328, may allow the first section 410 and the second section 420 of the multi-sectional blending tub 400 to be operated separately or in combination. Further, the first fracturing fluid, the first particulate matter, and the composition of the first slurry may be the same, or different than the second fracturing fluid, the second particulate matter, and the composition of the second slurry, respectively.

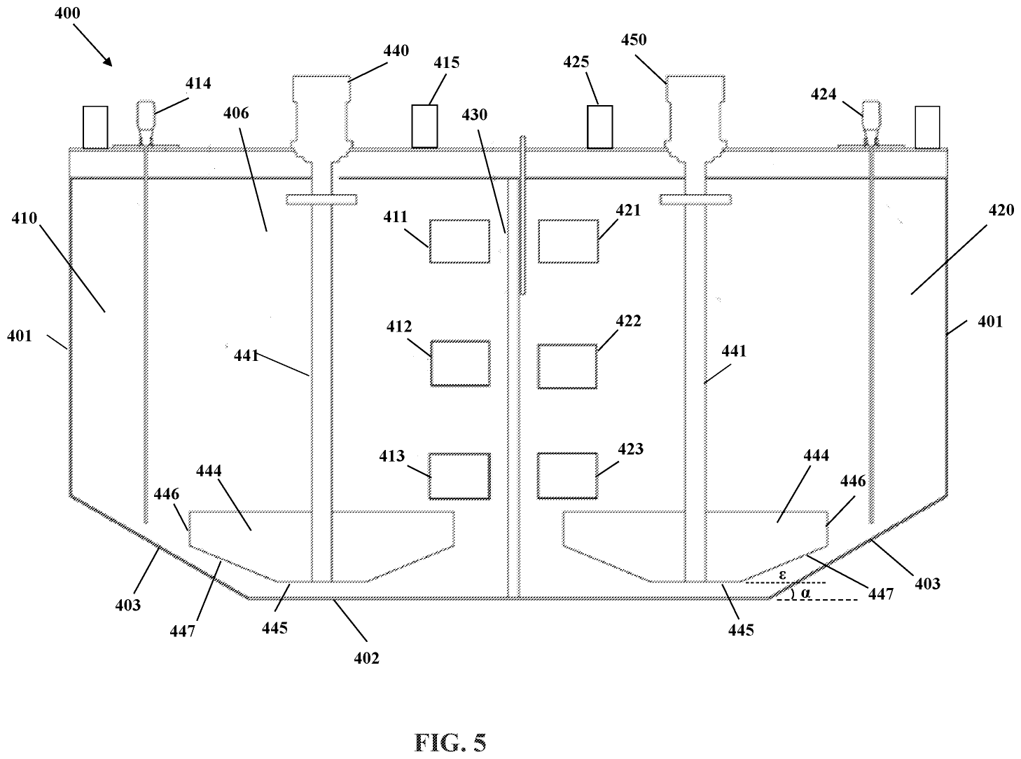

Referring to FIG. 5, a cross-sectional view of an embodiment of a multi-sectional blending tub 400 along line A-A of FIG. 4. The multi-sectional blending tub 400 may comprise a lower surface 402 and side wall 401 defining a blending cavity 406. The lower surface 402 of the blending tub 400 may be flat, and may further include an inclined portion 403 oriented at an acute angle α from horizontal. The multi-sectional blending tub 400 may include a first section 410, a second section, 420, and a divider 430 that divides the first and second sections 410, 420.

The first section 410 may comprise a first fracturing fluid inlet 412, a first impeller 440, a first discharge outlet 413, a first sensor 414, and a first prime up inlet 415. The first section 410 may receive a first particulate matter from the distribution chute 216. The first fracturing fluid inlet 412 may be positioned in a side wall of the multi-sectional blending tub 400 and may be operable to receive a first fracturing fluid from the first intake control valve 310. The first impeller 440 may be suspended from a permanent or removable bracket above the first section 410 and may be operable to rotate about a vertical axis within the first section 410 to mix the first particulate matter and the first fracturing fluid to produce a first slurry. The first discharge outlet 413 may be positioned in a side wall 401 of the multi-sectional blending tub 400 and below the first fracturing fluid inlet 412. The first discharge outlet 413 may be operable to transport the first slurry to the first discharge pump 314. The first sensor 414 may be disposed on a side wall of the first section 410 or suspended from above, and may be operable to detect a height of the first slurry in the first section 410. The first prime up inlet 415 may be positioned above of the multi-sectional blending tub 400 to access the first section 410 from above or in the upper portion of the sidewall 401 to access the first section 410 from the side. The first prime up inlet 415 may be operable to discharge the first fluid to the first prime up valve 326.

The second section 420 may comprise a second fracturing fluid inlet 422, a second impeller 450, a second discharge outlet 423, a second sensor 424, and a second prime up inlet 425. The second section 420 may be operable to receive a second particulate matter from the distribution chute 216. The second fracturing fluid inlet 422 may be positioned in a side wall 401 of the multi-sectional blending tub 400 and may be operable to receive a second fracturing fluid from the second intake control valve 312. The second impeller 450 may be suspended from a permanent or removable bracket above the second section 420 and may be operable to rotate about a vertical axis within the second section 420 to mix the second particulate matter and the second fracturing fluid to produce a second slurry. The second discharge outlet 423 may be positioned in a side wall 401 of the multi-sectional blending tub 400 and below the second fracturing fluid inlet 422. The second discharge outlet 423 may be operable to transport the second slurry to the second discharge pump 316. The second sensor 424 may be disposed on a side wall 401 of the second section 420 or suspended from above, and may be operable to detect a height of the second slurry in the second section 420. The second prime up inlet 425 is positioned above the multi-sectional blending tub 400 to access the second section 420 from above or in the upper portion of the sidewall 401 to access the second section 420 from the side. The second prime up inlet 425 may be operable to discharge the second slurry fluid to the second prime up valve 328.

The divider 430 may be insertable from above and is positioned within the multi-sectional blending tub 400 to separate the multi-sectional blending tub 400 into a first section 410 and a second section 420. The divider 430 may be insertable and removable, or alternatively, it may be permanently installed.

In one embodiment, the divider 430 may be removable from the multi-sectional blending tub 400, thereby eliminating the first section 410 and the second section 420 and creating a single blending tub with a larger capacity. Removing the divider 430 may be beneficial when the first particulate matter is the same as the second particulate matter and the desired compositions of the slurry are the same. The single tub may discharge the slurry composition to one or both of the first and second discharge pumps 314, 316. One benefit of removing the divider 430 is that it enables a greater volume of slurry to be mixed and therefore generated in the multi-sectional blending tub 400.

In one embodiment, the first and second impellers 440, 450 may be used to mix the slurry composition within the single blending tub. The first and second impellers 440, 450 may be operable to rotate independently of one another. Each impeller 440, 450 may rotate in either a clockwise or counterclockwise direction about a vertical axis. The first and second impellers 440, 450 may rotate in the same direction or in opposite directions. For instance, the first impeller 440 may rotate clockwise about a vertical axis within the first section 410 while the second impeller 450 rotates counterclockwise about a vertical axis within the second section 420. Rotating impellers 440, 450 in opposite directions may reduce aeration and facilitate a more homogenous composition by forcing the particulate matter downward and outward to the respective sides of the blending tub and then lifting and rolling up the particular matter off of the bottom and sides of the of the blending tub 400 toward the center and upper portions for further blending by the impellers, thereby improving the consistency of the slurry composition produced in the blending tub 400. In another embodiment, a single impeller may be suspended from a permanent or removable bracket above an undivided blending tub and may be operable to rotate about a vertical axis to mix a slurry composition.

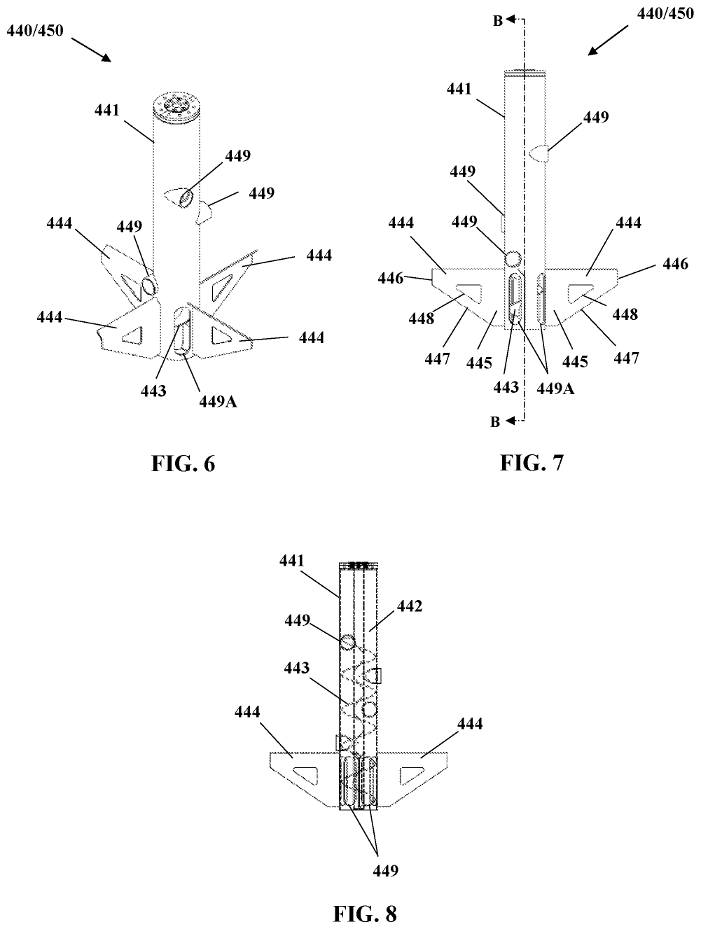

FIGS. 6-8 depict an embodiment of impeller 440, 450 for the multi-sectional blending tub 400. The impeller 440, 450 may comprise central shaft housing 441 along a vertical axis and a plurality of blades 444 disposed at the lower end of the shaft housing 441. Each blade 444 may have a root 445 extending outward from the shaft housing 441 and then form a generally triangular shape. The tip 446 of the blade 444 may be flat and substantially parallel with the side wall 401 of the blending tub 400. The blades 444 may have a leading, lower edge 447 that approximates the profile of the lower surface 402 of the blending tub 400 to sweep the particulate matter off the lower surface 402 of the blending tub 400. The leading, lower edge 447 may be oriented at an acute & angle which is less than that of the angle α of an inclined portion 403 of the lower surface 402 of the blending tub 400 to induce a more downwardly and outwardly directed flow of the particulate matter. The blades 444 of the impeller 440, 450 produce an axial flow force to the particulate matter downward and outward and then to lift and roll the particulate matter up off of the bottom and side of the blending tub 400 toward the center and upper portions for further blending by the impeller 440, 450 thereby improving the consistency of the slurry composition. The blades 444 may further include one or more apertures 448 therein to reduce the shear as the impeller 440, 450 is rotated within the slurry composition. The apertures 448 may be formed in a triangular shape and may approximate the profile of the blade 444.

The central shaft housing 441 may include a longitudinal channel 442 therethrough and which may be formed in the shape of a helical screw 443. The central shaft housing 441 may further include a plurality of ports, nozzles or apertures 449 along the length of the central shaft housing 441. The ports, nozzles, or apertures 449 may each be oriented in the same angles or at different angles. As the impeller 440, 450 is rotated, the slurry composition will enter the lower ports, nozzles, or apertures 449A within the central shaft housing 441 and travel up the channel 443 along the helical screw 443 in a screw motion until exits out of the ports, nozzles, or apertures 449 located at a position higher along the central shaft 441, which reduces aeration and cavitation during the mixing of the slurry composition.

Referring to FIGS. 1-3, the power generation system 500 powers and controls the blending tub system 100. The power generation system 500 may comprise one or more transformers for various voltage requirements, and one or more variable frequency drives (VFD) to vary the speed of the electric motors.

In one embodiment, the power generation system 500 may include motors 232 to power the sand screw or augers 218, first and second intake pump motors 332, 334 to power the intake pumps 306, 308, first and second discharge pump motors 342, 344 to power the discharge pumps 314, 316, and first and second impeller motors 462, 464 to power the impellers 440, 450. The power generation system 500 may also provide power to actuate the intake control valves 310, 312, the discharge control valve 318, 320, the prime up valves 326, 328 of the manifold system 300 and the other electrical components within the blending tub system 100. The power control system 500 may be operable to control the speed of the conveyer system 214, the speed of the intake pumps 306, 308, the speed of the discharge pumps 314, 316, the opening/closing of the intake control valves 310, 312, discharge valves 318, 320, and prime up valves 326, 328, and the speed and rotation (clockwise or counterclockwise) of the impellers 440, 450. In this way, the power generation system 500 is operable to control the operation of the multi-sectional blending tub system 100 to regulate the quantity, concentration, and level of the fluids and/or slurries within the multi-sectional blending tub 400 so that desired slurry compositions may be achieved.

Each of the components of the power generation system 500 may be mounted on the transportable support base 110. The VFDs may be housed within an electrical enclosure 502 on the transportable storage base 110. In other embodiments, one or more of the components of the power generation system 500 may be located remotely at the well site and electrically connected to the blending tub system 100.

Ae control system (not shown) may be provided on the support base 110 to provide for a user to control the operation of the multi-sectional blending tub system 100. The control system may also be located remotely to provide for a user to control the power generation system remotely via a cellular, internet, or similar connection from a smartphone, tablet, computer, or similar device.

The above description is only to preferred embodiments of the present invention and it should be noted that those skilled in the art can make improvements and modifications without departing from the technical principles of the present invention and as such, variations are also considered to be the scope of protection of the present invention.

What is claimed is:

1. A multi-sectional blending tub apparatus for use in well servicing operations, the multi-sectional blending tub comprising:
a. a blending tub including a side wall and an enclosed lower surface defining a blending cavity;
b. a removable divider insertable from the above and positioned within the blending cavity to separate the blending tub into a first section and a second section;
c. a first particulate inlet and a second particulate inlet positioned in the side wall of the blending tub, where the first particulate inlet receives particulate matter for delivery into the first section and the second particulate inlet receives particulate matter for delivery into the second section;
d. a first fluid inlet and a second fluid inlet positioned in the side wall of the of the blending tub and below the distribution chute, wherein the first fluid inlet receives a first fluid for delivery into the first section and the second fluid inlet receives a second fluid for delivery into the second section;
e. a first mixing impeller suspended from above and within the first section and a second mixing impeller suspended from above and within the second section, wherein the first mixing impeller mixes the first particulate matter and the first fluid to produce a first slurry composition in the first section, wherein the second mixing impeller mixes the second particulate matter and the second fluid to produce a second slurry composition in the second section;
f. a first slurry outlet positioned in the side wall of the first section and below the first fluid inlet and a second slurry outlet positioned in the side wall of the second section and below the second fluid inlet, wherein the first slurry outlet discharges the first slurry composition and the second slurry outlet discharges the second slurry composition for use in well servicing operations.

2. The multi-sectional blending tub apparatus of claim 1, further comprising:
a first level sensor that detects a level of the first slurry composition; and
a second sensor that detects a level of the second slurry.

3. The multi-sectional blending tub apparatus of claim 1, a distribution chute adjacent to the blending tub, wherein the distribution chute transports the first particulate matter through the first particulate inlet into the first section and the second particulate matter through the second particulate inlet into the second section.

4. The multi-sectional blending tub apparatus of claim 1, wherein the divider is removable to provide a single blending tub.

5. The multi-sectional blending tub apparatus of claim 4, wherein the first slurry and the second slurry compositions are the same.

6. The multi-sectional blending tub apparatus of claim 1, wherein the first mixing impeller is operable to rotate in a clockwise or counterclockwise direction about a vertical axis within the first section and the second mixing impeller is operable to rotate in a clockwise or counterclockwise direction about a vertical axis within the second section.

7. The multi-sectional blending tub apparatus of claim 1, wherein the first mixing impeller and the second mixing impeller rotate in opposite clockwise and counterclockwise directions.

8. The multi-sectional blending tub apparatus of claim 1, wherein the first slurry composition and second slurry composition are used in well servicing operations for the simultaneous fracturing of two or more wells.

9. The multi-sectional blending tub apparatus of claim 1, wherein the first and second mixing impellers each further comprise:
a central shaft extending along a longitudinal axis of the impeller, and
a plurality of blades that extend outward from a lower portion of the central shaft, wherein the blades are configured to generate an axial flow of the slurry composition in the blending tub.

10. The multi-sectional blending tub apparatus of claim 9, wherein the lower surface of the blending tub has an inclined portion oriented at an acute angle from horizontal, and
wherein the blades of the first and second mixing impeller each have a leading, lower edge oriented at an acute angle less than that of an angle of the inclined portion of the lower surface of the blending tub.

11. The multi-sectional blending tub apparatus of claim 9, wherein the central shaft of each of the first mixing impeller and the second mixing impellers each further comprises:
a longitudinal channel defined through the central shaft in the shape of a helical screw,
two or more nozzles disposed along the longitudinal length of the central shaft,
wherein one or more of the first fluid, the second fluid, the first slurry, and the second slurry are lifted through the channel from a lower portion of the blending tub to a higher portion of the blending tub as the impeller is rotated during mixing of the slurry composition in the blending tub.

12. The multi-sectional blending tub apparatus of claim 1, wherein blending tub apparatus is mounted on a transportable support base.

13. A blending tub apparatus for use in well servicing operations, the blending tub apparatus comprising:
a. a blending tub including a side wall and an enclosed lower surface;
b. a particulate inlet positioned in the side wall of the blending tub which receives particulate matter for delivery into the blending tub;
b. a fluid inlet positioned in the side wall of the of the blending tub which receives a first fluid for delivery into the blending tub;
c. a slurry outlet positioned in the side wall of the blending tub below the fluid inlet which discharges the slurry composition for use in well servicing operations; and
d. a mixing impeller suspended from above and within the blending tub, the mixing impeller comprising:
i. a hollow central shaft extending along a longitudinal axis of the impeller having a longitudinal channel therethrough in the shape of a helical screw,
ii. a plurality of blades that extend outward from a lower portion of the central shaft, wherein the blades are configured to generate an axial flow of the slurry composition in the blending tub,
iii. two or more nozzles disposed longitudinally along the length of the central shaft, wherein slurry is lifted through the channel from a lower portion of the blending tub to a higher portion of the blending tub as the impeller is rotated during mixing of the slurry composition in the blending tub.

14. The blending tub apparatus of claim 13, wherein the lower surface of the blending tub has an inclined portion oriented at an acute angle from horizontal, and
wherein the blades of the mixing impeller each have a leading, lower edge oriented at an acute angle less than that of an angle of the inclined portion of the lower surface of the blending tub.

15. A blending tub system for use in well servicing operations comprising:
a. a multi-sectional blending tub comprising:
i. a side wall and an enclosed lower surface defining a blending cavity;
ii. a removable divider insertable from the above and positioned within the blending cavity to separate the blending tub into a first section and a second section;
iii. a first particulate inlet and a second particulate inlet positioned in the side wall of the blending tub, where the first particulate inlet receives particulate matter for delivery into the first section and the second particulate inlet receives particulate matter for delivery into the second section;
iv. a first fluid inlet and a second fluid inlet positioned in the side wall of the of the blending tub and below the distribution chute, wherein the first fluid inlet receives a first fluid for delivery into the first section and the second fluid inlet receives a second fluid for delivery into the second section;
v. a first mixing impeller suspended from above and within the first section and a second mixing impeller suspended from above and within the second section, wherein the first mixing impeller mixes the first particulate matter and the first fluid to produce a first slurry composition in the first section, wherein the second mixing impeller mixes the second particulate matter and the second fluid to produce a second slurry composition in the second section;
vi. a first slurry outlet positioned in the side wall of the first section and below the first fluid inlet and a second slurry outlet positioned in the side wall of the second section and below the second fluid inlet, wherein the first slurry outlet discharges the first slurry composition and the second slurry outlet discharges the second slurry composition for use in well servicing operations.
b. a particulate delivery system which delivers the particulate matter to the first and second particulate inlets of the blending tub;
c. an intake manifold system including two or more intake pumps and two or more intake control valves for respectively controlling the intake of the first and second fluids to the first and second sections of the blending tub;
d. a discharge manifold system including two or more discharge pumps and two or more discharge control valves for respectively controlling the discharge of the first and second slurry compositions from the first and second sections of the blending tub;
e. a power generation system which powers and controls the particulate delivery system, the intake manifold system, and the discharge manifold system, and the first and second mixing impellers of the multi-sectional blending tub.
f. a single transportable base on which the blending tub, the particulate matter delivery system, the intake manifold system, the discharge manifold system, and the power generation system are mounted.

16. The blending tub system of claim 15, further comprising a distribution chute adjacent to the blending tub, wherein the distribution chute transports a first particulate matter from the particulate delivery system through the first particulate inlet into the first section and a second particulate matter from the particulate delivery system through the second particulate inlet into the second section.

17. The blending tub system of claim 15, wherein the power generation system comprises two or more electric motors to respectively power the two or more intake pumps, two or more electric motors to respectively power the two or more discharge pumps, and two or more motors to respectively power the first and second mixing impellers, and one or more variable frequency drives to respectively control the speed of the each of the electric motors.

18. The blending tub system of claim 15, wherein the first and second mixing impellers each further comprise:
a central shaft extending along a longitudinal axis of the impeller, and
a plurality of blades that extend outward from a lower portion of the central shaft, wherein the blades are configured to generate an axial flow of the slurry composition in the blending tub.

19. The multi-sectional blending tub apparatus of claim 18, wherein the lower surface of the blending tub has an inclined portion oriented at an acute angle from horizontal, and
wherein the blades of the first and second mixing impeller each have a leading, lower edge oriented at an acute angle less than that of an angle of the inclined portion of the lower surface of the blending tub.

20. The multi-sectional blending tub apparatus of claim 18, wherein the central shaft of each of the first mixing impeller and the second mixing impellers each further comprises:
a longitudinal channel defined through the central shaft in the shape of a helical screw,
two or more nozzles disposed along the longitudinal length of the central shaft, wherein one or more of the first fluid, the second fluid, the first slurry, and the second slurry are lifted through the channel from a lower portion of the blending tub to a higher portion of the blending tub as the impeller is rotated during mixing of the slurry composition in the blending tub.

21. The blending tub system of claim 15, wherein the transportable support base comprises one of a trailer, truck chassis, and skid.
